(19) United States
(12) Patent Application Publication
(10) Pub. No.: US 2020/0142966 A1
(43) Pub. Date: May 7, 2020

(54) ORGANIZING DISPARATELY STORED DOCUMENTS INTO A KNOWLEDGE CLOUD

(71) Applicant: Habla AI, Inc., San Jose, CA (US)

(72) Inventors: Kelly Qian, Fremont, CA (US); Thomas Knapp, San Jose, CA (US)

(21) Appl. No.: 16/178,587

(22) Filed: Nov. 2, 2018

(51) Int. Cl. G06F 17/30

(52) U.S. Cl. CPC G06F 17/30011; G06F 17/30657; G06F 17/30197; G06F 17/30716; G06F 17/30696

(57) ABSTRACT

Providing an organized knowledge cloud can include: obtaining a user-selection of a set of documents scattered among a set of disparate document storage services for inclusion in a document integration; determining a set of document integration parameters for each document selected for the document integration; and generating a visual depiction of one or more of the documents included in the document integration in response to the document integration parameters such that the visual depiction enables user access to one or more of the documents included in the visual depiction.

### BACKGROUND

A variety of knowledge can be contained in digital documents stored on document storage services. Examples of document storage services include cloud-based services such as Box, Dropbox, Google Drive, Sharepoint, etc.

An individual or a team of individuals, e.g., an enterprise team working on a project, may access documents scattered among multiple disparate document storage services. For example, an individual or team of individuals preparing a business proposal may access relevant knowledge contained in documents stored on Box, and documents stored on Dropbox, and documents stored on Google Drive, etc.

An individual accessing documents scattered among multiple disparate document storage services must often go through an arduous and time-consuming process of logging onto each document storage service, often multiple times, and presenting the proper credentials to each document storage service. In addition, documents scattered among multiple disparate document storage services may have unknown and disparate naming conventions and directory structures which can complicate efforts to find needed documents.

### SUMMARY

In general, in one aspect, the invention relates to a knowledge cloud organizer. A knowledge cloud organizer according to the invention can include: a document selector that enables user-selection of a set of documents scattered among a set of disparate document storage services for inclusion in a document integration, and that determines a set of document integration parameters for each document selected for the document integration; and a knowledge cloud access portal that in response to the document integration parameters generates a visual depiction of one or more of the documents included in the document integration such that the visual depiction enables user access to one or more of the documents included in the visual depiction.

In general, in another aspect, the invention relates to a method for organizing a knowledge cloud. The method can include: obtaining a user-selection of a set of documents scattered among a set of disparate document storage services for inclusion in a document integration; determining a set of document integration parameters for each document selected for the document integration; and generating a visual depiction of one or more of the documents included in the document integration in response to the document integration parameters such that the visual depiction enables user access to one or more of the documents included in the visual depiction.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a knowledge cloud organizer in one or more embodiments.

FIG. 2 illustrates example sets of document integration parameters in one or more embodiments.

FIG. 3 is an example timeline depicting document creation activities involving a set of documents selected for a document integration.

FIGS. 4A-4B illustrate an example of a zoomable timeline of activities pertaining to a document integration in one or more embodiments.

FIG. 5 illustrates an embodiment of a knowledge cloud organizer that provides enhanced search capabilities.

FIG. 6 shows an example visual depiction of a set of documents of a document integration that match to a set of search terms.

FIGS. 7A-7B illustrate a user interface in one or more embodiments that enables user-selection of a set of operators for combining a set of search terms.

FIGS. 8A-8B illustrate a set of user interface elements in one or more embodiments that enable a selective disabling individual search terms.

FIG. 9 illustrates a method for method for providing an organized knowledge cloud in one or more embodiments.

FIG. 10 illustrates a computing system upon which portions of a knowledge cloud organizer can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

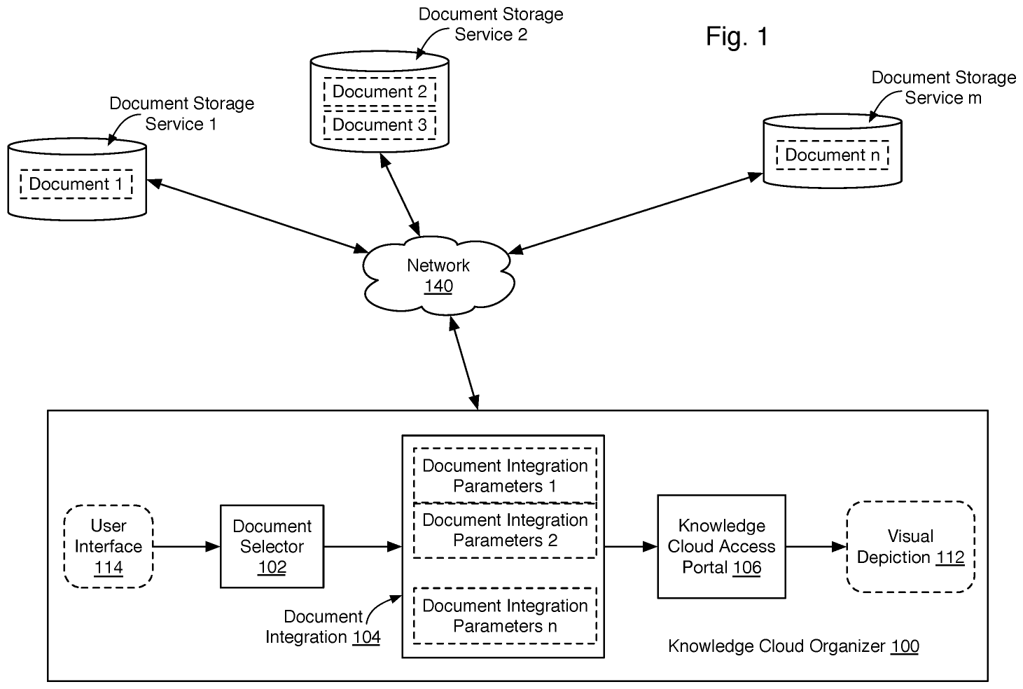

FIG. 1 illustrates a knowledge cloud organizer 100 in one or more embodiments. The knowledge cloud organizer 100 includes a document selector 102 that enables user-selection of a set of documents 1-n scattered across a set of disparate document storage services 1-m for inclusion in a document integration 104 for a knowledge cloud.

The documents 1-n can include any type of digital documents in any format, e.g., industry standard formats. Examples of the documents 1-n include text files, e.g., word files, image files, e.g., jpeg, tiff, etc., PDF files, video/movie files, data files, planning/organization files, financial files, etc.

The document storage services 1-m can include any selection and arrangement of document storage services including so-called cloud-based services e.g., Dropbox, Box, Sharepoint, Google Drive, etc., accessible via a network 140, using e.g., Internet protocols.

The document integration 104 can be based on a team, a project, an organization, etc. In one or more embodiments, the document selector 102 generates a user interface 114 that enables a user to specify a team name, team identifier, etc., for the document integration 104, and identify one or more individuals for inclusion in the team, and enable browsing of the document storage services 1-m and individual selection of the documents 1-n for inclusion in the document integration 104 for a specified team.

The document selector 102 determines a respective set of document integration parameters 1-n for each document 1-n selected for the document integration 104. For example, the document integration parameters 1 correspond to the document 1, the document integration parameters 2 correspond to the document 2, etc.

The document integration parameters 1-n can include document names and types, document creation parameters, document ownership parameters, document modification parameters, document size parameters, document sharing information, document version parameters, keywords, etc. The document integration parameters 1-n include identifications of the document storage services 1-m where the respective documents 1-n are stored along corresponding credentials for accessing the document storage services 1-m.

For example, when a user via the user interface 114 selects the document 1 for inclusion in the document integration 104, the document selector 102 can obtain document name and type, creation, modification, etc., parameters for the document 1 from the document storage service 1 and include such parameters in the document integration parameters 1 along with a set of local parameters, e.g., team identifier, and credentials for accessing the document 1 on the document storage service 1. Likewise, when a user selects the document 2 for inclusion in the document integration 104, the document selector 102 can obtain document name and type, etc. parameters from the document storage service 2 and include such parameters in the document integration parameters 2 along with local parameters and credentials for accessing the document 2 on the document storage service 2.

The document integration parameters 1-n can include any selection and arrangement of any kinds of documents stored on any selection and arrangement of the disparate document storage services 1-m. The document integration parameters 1-n can be stored in a database of the knowledge cloud organizer 100.

The knowledge cloud organizer 100 includes a knowledge cloud access portal 106 that generates a visual depiction 112 of one or more of the documents 1-n included in the document integration 104 in response to the document integration parameters 1-n. The visual depiction 112 can depict the documents 1-n using document names, icons, versions, activities, types, sizes, etc.

The knowledge cloud organizer 100 provides smart search and sort functions that enable a user to search for documents in the document integration 104 by matching a set of search terms to any combination of the document integration parameters 1-n so that only matching documents appear in the visual depiction 112. A user can sort the matching documents in the visual depiction 112 by any of the document integration parameters 1-n. For example, a user can search for documents in the document integration 104 by entering search terms that match to document names, user names, document activities, dates, document types, etc., and sort the results by document name, user name, dates, document type, document size, etc. A smart search can include user-selectable operators for combining search terms to yield exact matches, near matches, etc.

The visual depiction 112 enables user access to one or more of the documents 1-n included in the document integration 104. In one or more embodiments, the visual depiction 112 enables user-access by identifying on which of the document storage services 1-m each document included in the document integration 104 is stored. For example, the visual depiction 112 can identify the document storage services 1-m using a unique name, acronym, abbreviation, etc., associated with each document storage service 1-m. The visual depiction 112 can identify the document storage services 1-m using a unique icon associated with each document storage service 1-m.

In one or more embodiments, the visual depiction 112 enables user-access by including a document storage service link, e.g., a URL, for each document 1-n included in the document integration 104. For example, the visual depiction 112 can include a link to the document storage service 1 for the document 1 including a respective set of security credentials for accessing the document 1 from the document storage service 1. Likewise, the visual depiction 112 can include a link to the document storage service 2 for the document 2 including a respective set of security credentials for accessing the document 2 from the document storage service 2.

In one or more embodiments, the visual depiction 112 includes a timeline of a series activities involving the documents 1-n included in the document integration 104. Examples of activities that can be depicted in a timeline include document creation, document modification, document accesses, etc. A timeline in the visual depiction 112 can be zoomable under user-control.

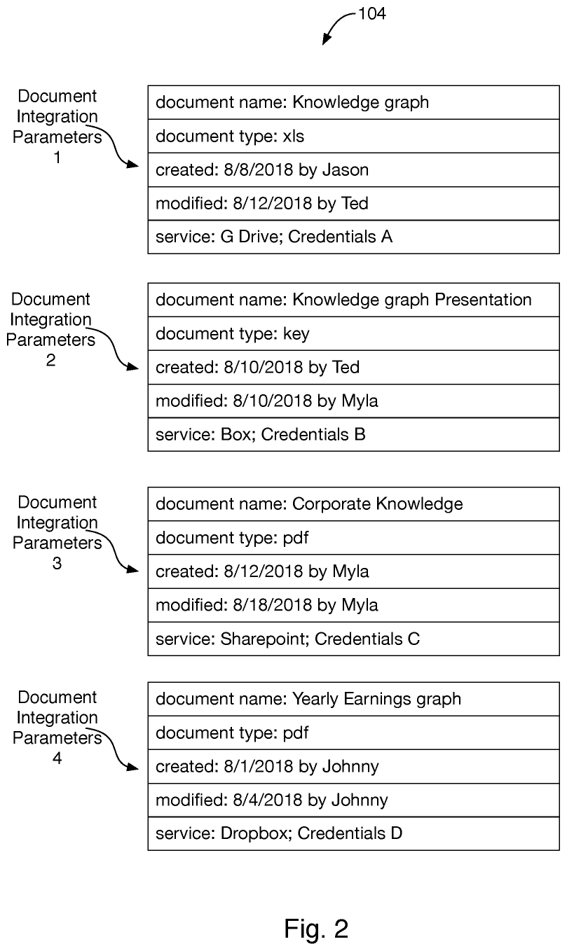

FIG. 2 shows an example set of document integration parameters 1-4 in one or more embodiments. In this example, each set of document integration parameters 1-4 includes a document name, a document type, a set of “created” by parameters including date and username, a set of “modified” by parameters including date and username, and a set of “service” parameters including the name the document storage service 1-m where the corresponding document 1-4 is stored and a set of credentials for accessing the corresponding document 1-4 on that document storage service.

For example, the document integration parameters 1 correspond to an xls document named Knowledge graph created on Aug. 8, 2018 by Jason, modified on Aug. 12, 2018 by Ted, and stored on G Drive (Google Drive) with Credentials A. Likewise, the document integration parameters 2 correspond to a keynote document named Knowledge graph Presentation created on Aug. 10, 2018 by Ted, modified on Aug. 10, 2018 by Myla, and stored on Box with Credentials B.

A set of credentials in the document integration parameters 1-4 can include, e.g., a login user name and password for the respective document storage service 1-m. A set of credentials in the document integration parameters 1-4 can include a security token for accessing the respective document storage service 1-m. A set of credentials in the document integration parameters 1-4 can include a set of application programming interface (API) parameters, procedures, directory structure parameters, etc., for accessing the respective document storage service 1-m.

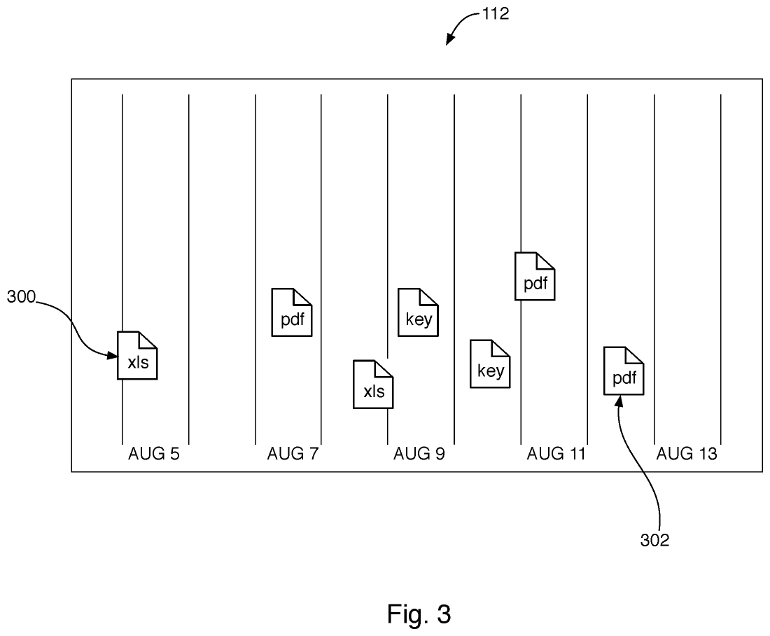

FIG. 3 illustrates an example timeline in the visual depiction 112 that depicts document creation activities involving the documents 1-n included in the document integration 104. For example, an icon 300 labeled xls depicts the creation of the xls document named Knowledge graph on Aug. 5, 2018 by Tom, and an icon 302 labeled pdf depicts the creation of the pdf document named Corporate Knowledge graph on Aug. 12, 2018 by January.

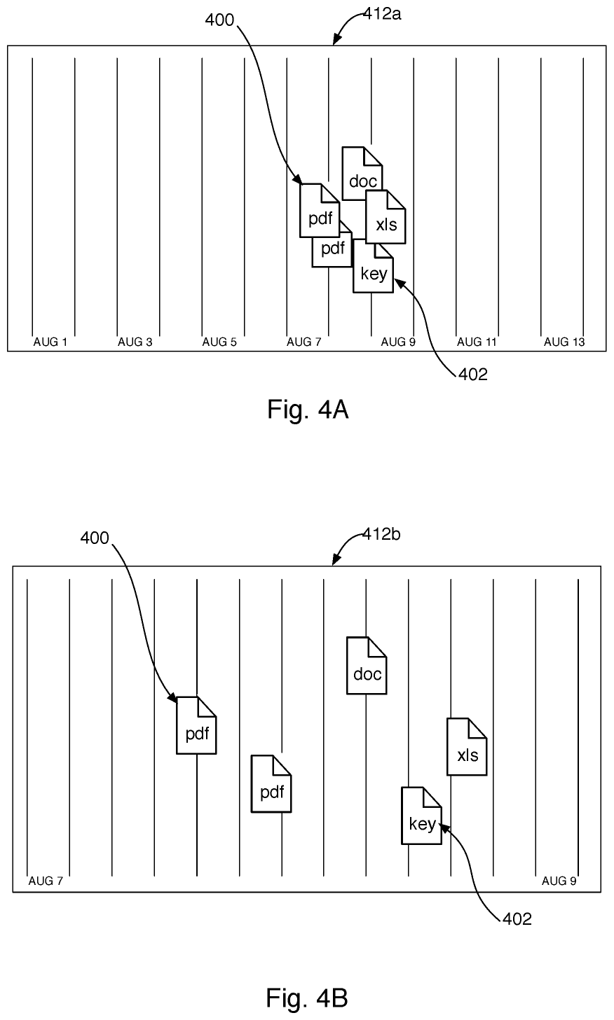

FIGS. 4A-4B illustrate an example of a zoomable timeline of activities in one or more embodiments. A visual depiction 412a of a timeline shows a set of five documents, e.g., a document 400 and a document 402, in a document integration clustered by corresponding activities that occur between August 7 and August 9.

FIG. 4B shows a visual depiction 412b after a “zoom-in” under user control. A zoomed-in timeline improves the visual time resolution of activities associated with the five documents in the document integration. In one or more embodiments, a zoom-in provides up to a one minute resolution in depicting the activities for the documents.

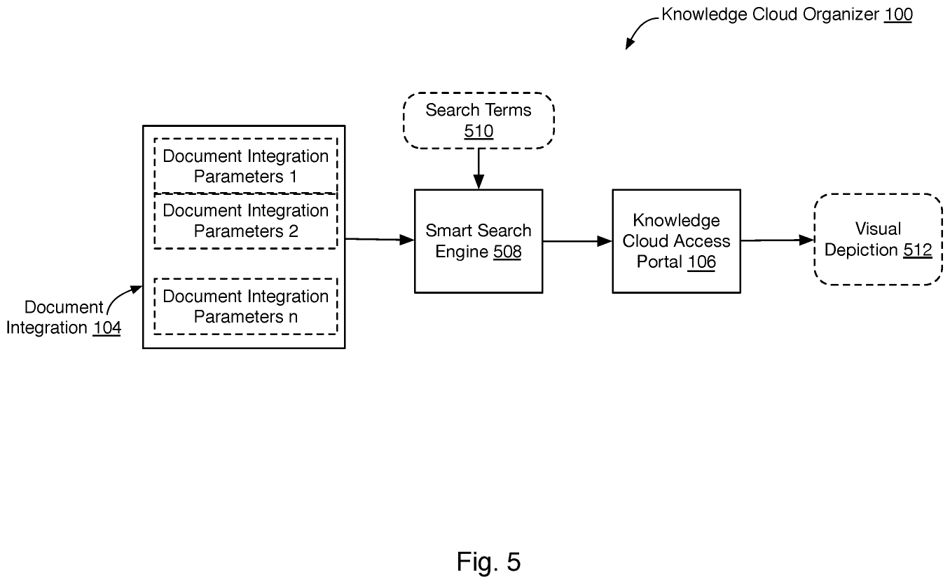

FIG. 5 shows an embodiment of the knowledge cloud organizer 100 that includes a smart search engine 508 with enhanced search capabilities. The smart search engine 508 determines which of the documents 1-n included in the document integration 104 match to a set of search terms 510. The search terms 510 can be entered by a user of the knowledge cloud organizer 100 via a user interface. The smart search engine 508 can match the search terms 510 to any of the document integration parameters 1-n included in the document integration 104, e.g., to document names, keywords, activities, etc.

The knowledge cloud access portal 106 generates a visual depiction 512 of the matching documents found by the smart search engine 508. The visual depiction 512 can depict the matching documents using document names, icons, versions, activities, types, sizes, etc. The visual depiction 512 can enable user access to the matching documents as previously described.

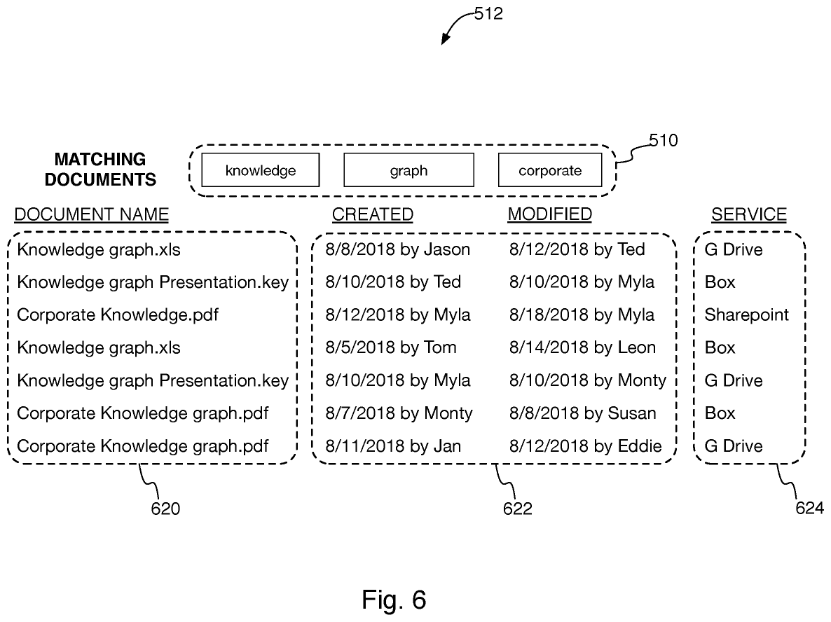

FIG. 6 illustrates an example embodiment in which the visual depiction 512 includes a set of fields 620-624 for depicting the documents 1-n of the document integration 104 that match to the search terms 510. The fields 620 depict document names, the fields 622 depict activities, and the fields 624 identify the document storage services 1-m. The search terms 510 in this example include “knowledge”, “graph”, and “corporate”.

In one or more embodiments, links to the specified matching documents are embedded in the fields 620. For example, when a user selects, e.g., clicks, on “Knowledge graph.xls” the knowledge cloud organizer 100 generates an access to Google Drive with the Credentials A listed in the document integration parameters 1 (FIG. 2) to directly access Knowledge graph.xls via the visual depiction 512.

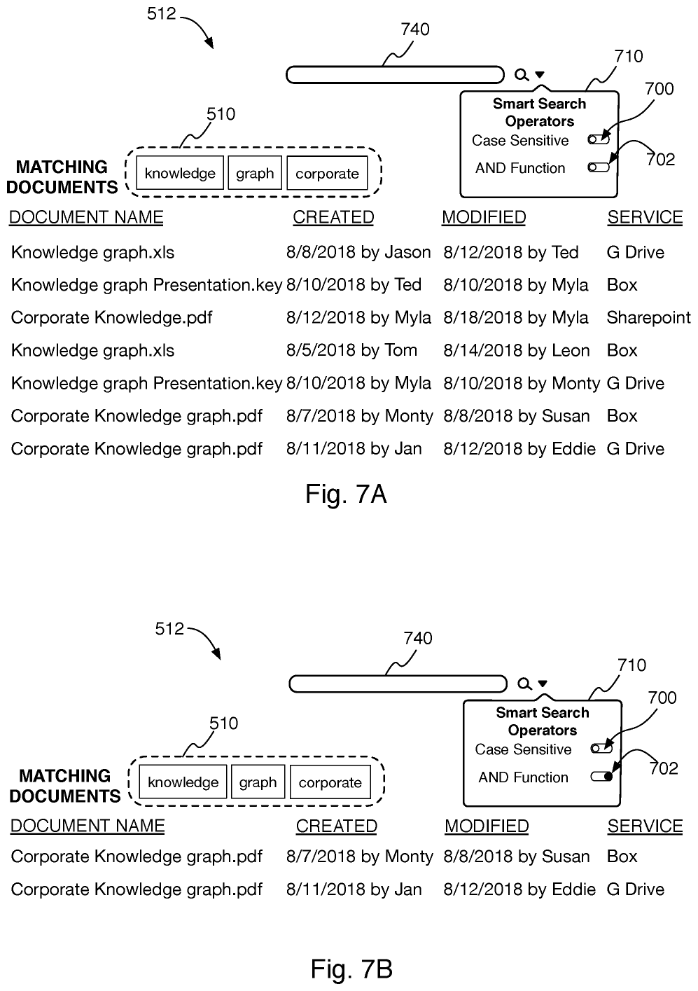

FIGS. 7A-7B illustrate a user interface 710 in one or more embodiments of the visual depiction 512 that enables user-selection of a set of operators for combining the search terms 510. In this example, the user interface 710 is a popup window that includes an on/off switch 700 for controlling a case sensitivity for the search terms 510 and an on/off switch 702 for controlling an AND function for the search terms 510. In this example, the popup window 710 is presented next to an input field 740 that enables a user to enter the search terms 510.

FIG. 7A shows a set of matching documents yielded when both the case sensitivity and the AND function switches 700-702 are off. FIG. 7B shows a set of matching documents yielded when the case sensitivity switch 700 is off and the AND function switch 702 is on. In one or more embodiments, the knowledge cloud organizer 100 automatically updates the matching documents depicted in the visual depiction 512 in response to changes in the switch 700-702 settings.

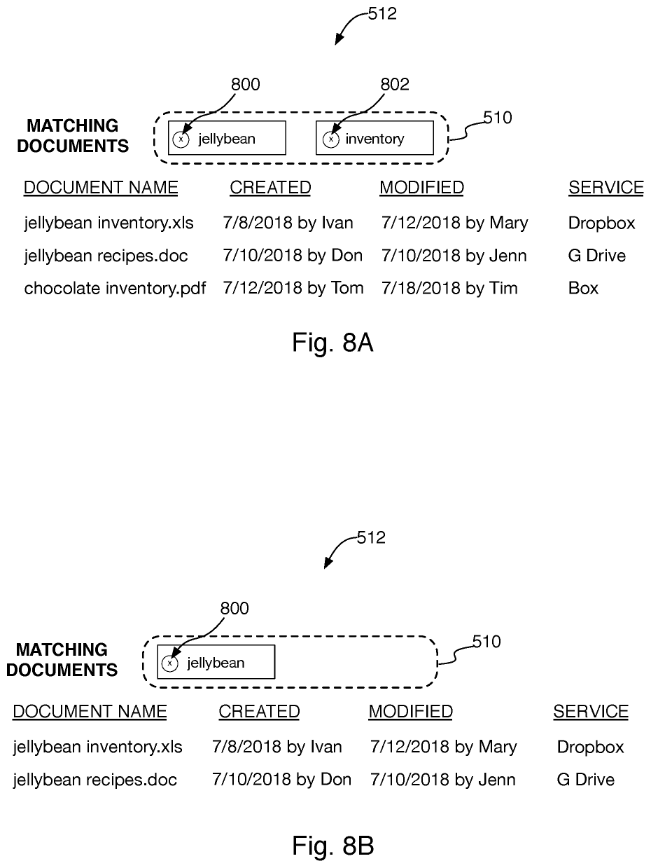

FIGS. 8A-8B illustrate a set of user interface elements 800-802 in one or more embodiments of the visual depiction 512 that enable a selective disabling of each of the search terms 510, individually, under user control. In this example, the user interface element 800 is for disabling the search term “jellybean” and the user interface element 802 is for disabling the search term “inventory”.

FIG. 8A shows a set of matching documents yielded by both of the search terms “jellybean” and “inventory” whereas FIG. 8B shows a set of matching documents yielded when a user has disabled the search term “inventory” by clicking the user interface element 802.

In some embodiments, the disabled search term “inventory” can be merely dimmed so that it can easily be reenabled by a user to reinclude it in a subsequent search.

In one or more embodiments, the knowledge cloud organizer 100 automatically updates the matching documents depicted in the visual depiction 512 in response to actuations made via the user interface elements 800-802.

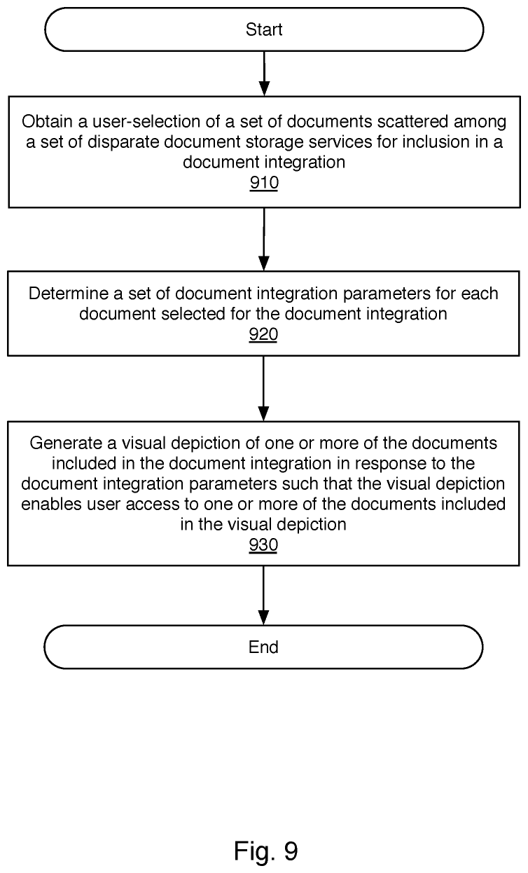

FIG. 9 illustrates a method for organizing a knowledge cloud in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 9 should not be construed as limiting the scope of the invention.

At step 910, a user-selection is obtained of a set of documents scattered among a set of disparate document storage services for inclusion in a document integration. Step 910 can include selecting a team identifier, organization identifier, etc., for a document integration. Step 910 can include selecting a set of individuals to be included a specified team. Step 910 can include browsing one or more of a set of disparate document storage services and selecting among the documents on the disparate document storage services for inclusion in a document integration.

At step 920, a set of document integration parameters are determined for each document included in a document integration. Step 920 can include obtaining a set of parameters for a document included in a document integration from a document storage service where it is stored. Step 920 can include obtaining a set of local parameters for a document included in a document integration.

At step 930, a visual depiction is generated of one or more of the documents included in a document integration in response to the document integration parameters. A visual depiction at step 930 enables user access to one or more of the documents included in the visual depiction. A visual depiction at step 930 can identify the document storage services where documents are stored. A visual depiction at step 930 can include links with credentials to the document storage services where the documents are stored. A visual depiction at step 930 can depict a timeline of activities pertaining to the documents, e.g., a zoomable timeline.

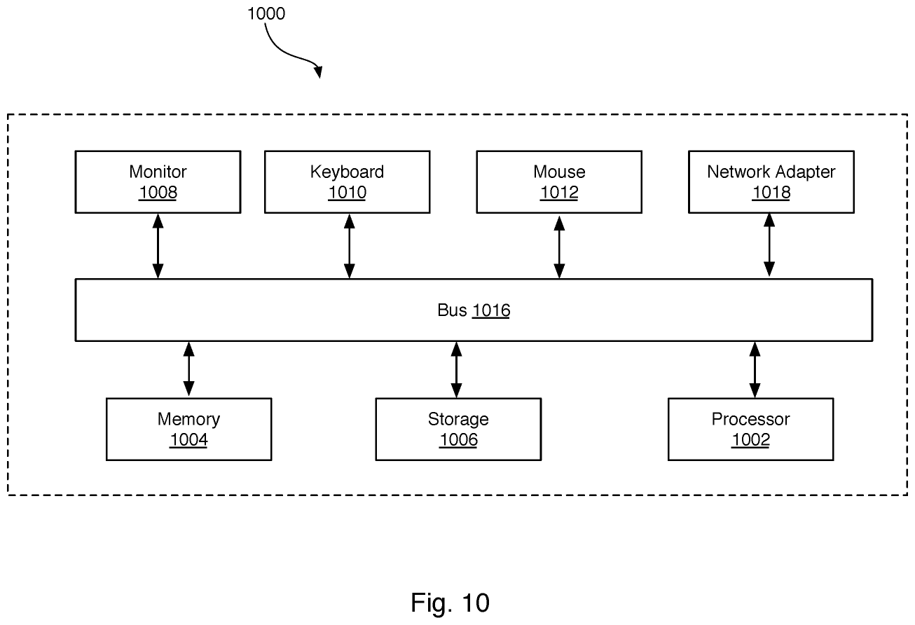

FIG. 10 illustrates a computing system 1000 upon which portions of the knowledge cloud organizer 100 can be implemented. The computing system 1000 includes one or more computer processor(s) 1002, associated memory 1004 (e.g., random access memory (RAM), cache memory, flash memory, etc.), one or more storage device(s) 1006 (e.g., a hard disk, an optical drive such as a compact disk (CD) drive or digital versatile disk (DVD) drive, a flash memory stick, etc.), a bus 1016, and numerous other elements and functionalities.

The computer processor(s) 1002 may be an integrated circuit for processing instructions. For example, the computer processor(s) may be one or more cores or micro-cores of a processor. The computing system 1000 may also include one or more input device(s), e.g., a touchscreen, keyboard 1010, mouse 1012, microphone, touchpad, electronic pen, or any other type of input device. Further, the computing system 1000 may include one or more monitor device(s) 1008, such as a screen (e.g., a liquid crystal display (LCD), a plasma display, touchscreen, cathode ray tube (CRT) monitor, projector, or other display device), external storage, input for an electric instrument, or any other output device. The computing system 1000 may be connected to, e.g., a local area network (LAN), a wide area network (WAN) such as the Internet, mobile network, or any other type of network) via a network adapter 1018.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A knowledge cloud organizer, comprising:
a document selector that enables user-selection of a set of documents scattered among a set of disparate document storage services for inclusion in a document integration for a knowledge cloud and that determines a set of document integration parameters for each document selected for the document integration; and
a knowledge cloud access portal that in response to the document integration parameters generates a visual depiction of one or more of the documents included in the document integration such that the visual depiction enables user access to one or more of the documents included in the visual depiction.

2. The knowledge cloud organizer of claim 1, wherein the knowledge cloud access portal enables user access by identifying in the visual depiction which of the document storage services holds at least one of the documents included in the visual depiction.

3. The knowledge cloud organizer of claim 1, wherein the knowledge cloud access portal enables user access by including a link in the visual depiction to the respective document storage service holding at least one of the documents included in the visual depiction.

4. The knowledge cloud organizer of claim 1, wherein the visual depiction includes a timeline of a set activities involving one or more of the documents included in the document integration.

5. The knowledge cloud organizer of claim 4, wherein the timeline is zoomable under user-control.

6. The knowledge cloud organizer of claim 1, further comprising a smart search engine that determines which of the documents in the document integration match to a set of search terms by generating a user interface for obtaining a user-selection of at least one operator for combining the search terms.

7. The knowledge cloud organizer of claim 6, wherein the operator for combining the search terms comprises an AND operator.

8. The knowledge cloud organizer of claim 6, wherein the operator for combining the search terms comprises a case sensitivity operator.

9. The knowledge cloud organizer of claim 6, further comprising a user interface that enables a selective disabling of at least one of the search terms under user control such that the documents in the visual depiction are automatically updated in response to a disabling of the search term.

10. A method for organizing a knowledge cloud, comprising:
obtaining a user-selection of a set of documents scattered among a set of disparate document storage services for inclusion in a document integration;
determining a set of document integration parameters for each document selected for the document integration; and
generating a visual depiction of one or more of the documents included in the document integration in response to the document integration parameters such that the visual depiction enables user access to one or more of the documents included in the visual depiction.

11. The method of claim 10, wherein generating a visual depiction includes identifying in the visual depiction which of the document storage services holds at least one of the documents included in the visual depiction.

12. The method of claim 10, wherein generating a visual depiction includes providing a link in the visual depiction to the respective document storage service holding at least one of the documents included in the visual depiction.

13. The method of claim 10, wherein generating a visual depiction includes generating a timeline of a set activities involving one or more of the documents included in the document integration.

14. The method of claim 13, wherein generating a timeline comprises generating a timeline zoomable under user-control.

15. The method of claim 10, further comprising determining which of the documents in the document integration match to a set of search terms including generating a user interface for obtaining a user-selection of at least one operator for combining the search terms.

16. The method of claim 15, wherein generating a user interface comprises generating a user interface for obtaining a user-selection of an AND operator.

17. The method of claim 15, wherein generating a user interface comprises generating a user interface for obtaining a user-selection of a case sensitivity operator.

18. The method of claim 15, further comprising generating a user interface that enables a disabling of at least one of the search terms under user control and updating the documents in the visual depiction in response to the disabling of the search term.
